(19) United States
(12) Patent Application Publication
(10) Pub. No.: US 2008/0129772 A1
(43) Pub. Date: Jun. 5, 2008

(54) APPARATUS AND METHOD OF PREVENTING DRYING OF INK IN INKJET PRINTHEAD AND PRINTING METHOD USING INKJET PRINTER

(75) Inventors: Sung-woong KIM, Yongin-si (KR); Seok-soon Baek, Yongin-si (KR); Sang-il Kim, Yongin-si (KR); Woo-sik KIM, Yongin-si (KR); Byung-hun Kim, Yongin-si (KR); Seong-jin Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/762,888

(22) Filed: Jun. 14, 2007

(30) Foreign Application Priority Data
Dec. 1, 2006 (KR) 2006-120955

(51) Int. Cl. B41J 29/38

(52) U.S. Cl. 347/14; 347/10

(57) ABSTRACT

An apparatus and method of printing for use in an inkjet printer includes vibrating, while moving an inkjet printhead from a standby position to a printing position, a meniscus of ink in a nozzle by applying an auxiliary pulse having a size not large enough to generate ink ejection to an actuator which provides driving force for ink ejection, and printing by applying a main pulse for ejecting ink when the inkjet printhead arrives at the printing position. Accordingly, ink can be ejected stably.

### CROSS-REFERENCE TO RELATED APPLICATIONS

This application claims the benefit of Korean Patent Application No. 10-2006-0120955, filed on Dec. 1, 2006 in the Korean Intellectual Property Office, the disclosure of which is incorporated herein in its entirety by reference.

### BACKGROUND OF THE INVENTION

1. Field of the Invention

The present general inventive concept relates to an apparatus and method of preventing drying of ink in an inkjet printhead, and an apparatus and method of printing using an inkjet printer providing stable ink ejection.

2. Description of the Related Art

An inkjet printhead is an apparatus that ejects minute droplets of printing ink on desired positions of recording medium in order to print predetermined color images. Inkjet printers include inkjet printheads for ejecting ink. Inkjet printheads are categorized into two types according to the ink ejection mechanism thereof. The first one is a thermal inkjet printhead that ejects ink due to an expansion force of bubbles generated in ink by thermal energy. The other one is a piezoelectric inkjet printhead that ejects ink droplets by pressure applied to ink due to the deformation of a piezoelectric body.

While no printing is performed, ink still remains inside a nozzle of the inkjet printhead. While no printing is performed, the ink inside the nozzle is not flowing and as such remains motionless. Accordingly, solvents in the ink evaporate, thereby increasing the viscosity of the ink in the nozzle. As the evaporation goes on, a thin layer is formed on the outer surface of the ink. When the viscosity of the ink increases or a thin layer is formed on outer surface of the ink, ejection may deteriorate such that no ink is ejected at the initial stage of printing. Also, even when ink is ejected, the ejection direction of the ink may be distorted and printing may not be performed at the correct position.

### SUMMARY OF THE INVENTION

The present general inventive concept provides an apparatus and method of preventing drying of ink in an inkjet printhead to effectively prevent drying of ink while no printing is performed, and an apparatus and method of printing using an inkjet printer providing stable ink ejection.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of printing of an inkjet printer, the method including vibrating a meniscus of ink in a nozzle by applying an auxiliary pulse having a size not large enough to generate ink ejection to an actuator which provides a driving force for ink ejection when an inkjet printhead moved from a standby position to a printing position, and printing by applying a main pulse to eject ink when the inkjet printhead arrives at the printing position.

Before moving the inkjet printhead to the printing position, a spitting operation ejecting ink may be performed several times at the standby position.

The printing method may further comprise applying the auxiliary pulse to the actuator while the inkjet printhead is positioned at the standby position.

The auxiliary pulse may be applied to the actuator while no printing is performed.

The foregoing and/or other aspects and utilities of the present general inventive concept may also be achieved by providing a method of preventing drying of ink of an inkjet printhead, the method including vibrating a meniscus of ink in a nozzle by applying an auxiliary pulse having a size not large enough to generate ink ejection to an actuator which provides driving force for ink ejection when no printing is performed, so that the ink in the nozzle flows and thus the ink near the nozzle is not dried.

The foregoing and/or other aspects and utilities of the present general inventive concept may also be achieved by providing a method of an image forming apparatus, the method including generating an auxiliary signal to generate one or more waves to vibrate at least a portion of ink disposed in a nozzle in a non-printing operation.

The method may further include generating a main driving signal to eject ink through the nozzle in a printing operation.

The method may further include controlling a printhead having the nozzle to move between a standby position and a printing position with respect to a medium, wherein the auxiliary signal is applied to the printhead when the printhead is in the standby position.

The generating of the auxiliary signal may include generating the auxiliary signal having a level such that the portion of the ink disposed in the nozzle is not ejected through the nozzle.

The generating of the auxiliary signal may include controlling the portion of the ink to move within the nozzle.

The foregoing and/or other aspects and utilities of the present general inventive concept may also be achieved by providing an image forming apparatus including a printhead having a nozzle, and a controller to generate an auxiliary signal the printhead to generate one or more waves to vibrate at least a portion of ink disposed in the nozzle in a non-printing operation.

The controller may control the printhead having the nozzle to move between a standby position and a printing position with respect to a medium, and the auxiliary signal is applied to the printhead when the printhead is in the standby position.

The controller may generate the auxiliary signal having a level such that the portion of the ink disposed in the nozzle is not ejected through the nozzle.

The controller may control the portion of the ink to move within the nozzle.

The controller may control the portion of the ink to change a contact point between a surface of the ink and an inner wall of the nozzle.

The controller may generate the auxiliary signal according to a time period from a printing operation.

The controller may generate the auxiliary signal according to a time period from an ink ejection operation.

The controller may generate a main driving signal to eject the ink from the nozzle, and the auxiliary signal is a small signal than the main driving signal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating an inkjet printer to perform a printing method according an embodiment of the present general inventive concept;

FIG. 2 is a cross-sectional view illustrating an inkjet printhead to perform a printing method according an embodiment of the present general inventive concept;

FIG. 3 illustrates an auxiliary pulse and a main pulse used in a printing method according to an embodiment of the present general inventive concept;

FIG. 4 illustrates movement of ink disposed near a nozzle when an auxiliary pulse is applied using a printing method according to an embodiment of the present general inventive concept;

FIG. 5A is a photographic image illustrating a printing result at an initial stage of printing when no auxiliary pulse is applied in a conventional printer; and

FIG. 5B is a photographic image illustrating a printing result at an initial stage of printing when an auxiliary pulse is applied using a printing method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept relates to an apparatus and method of preventing drying of ink in an inkjet printhead and an apparatus and method of printing using an inkjet printer providing stable ink ejection.

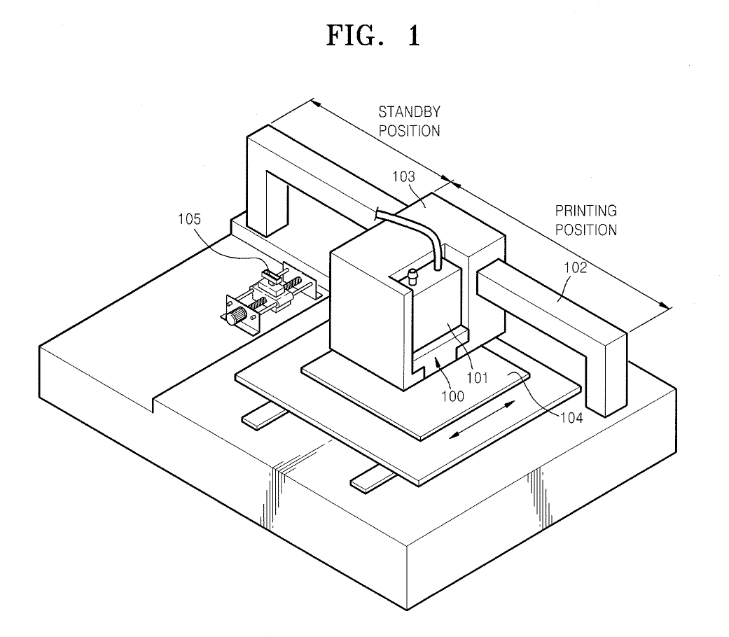

FIG. 1 is a perspective view illustrating an inkjet printer using a printing method according to an embodiment of the present general inventive concept. Referring to FIG. 1, an inkjet printhead 100 can be manufactured as a chip using various methods such as a semiconductor manufacturing process. The inkjet printhead 100 is connected to an ink reservoir 101. Ink is supplied from the ink reservoir 101 to the inkjet printhead 100. The ink reservoir 101 is connected to an ink tank that is not shown and can receive ink from the ink tank.

The inkjet printhead 100 and the ink reservoir 101 are mounted in a carriage 103. The carriage 103 is moved by a driving unit (not shown) along a guide member 102. A medium to be printed 104 is moved in a direction perpendicular to the direction in which the carriage 103 moves, to be disposed to face the inkjet print head 100 using a feeding unit (not illustrated). Before printing, the inkjet printhead 100 is positioned at a standby position outside of a printing region. While at the standby position, the inkjet printhead 100 can be capped by a capping unit 105.

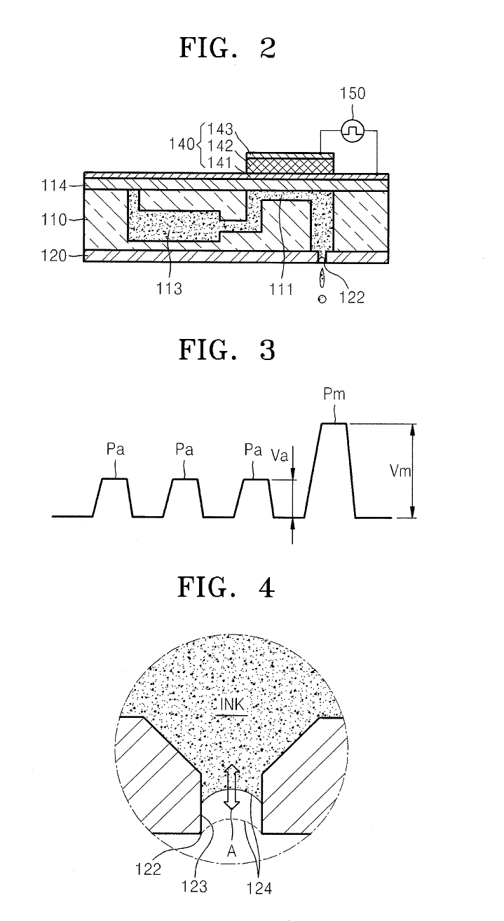

FIG. 2 is a cross-sectional view of an inkjet printhead 100 in which a printing method according to an embodiment of the present invention can be employed. The inkjet printhead 100 of FIG. 2 is the piezoelectric inkjet printhead. Referring to FIGS. 1 and 2, the inkjet printhead 100 includes a substrate 110 in which an ink passage is formed and a piezoelectric actuator 140 to provide ink ejection pressure. The substrate 110 includes a pressure chamber 111 and a manifold 113 to supply ink to the pressure chamber 111. A nozzle substrate 120, in which a nozzle 122 connected in line with the pressure chamber 111 is formed, is bonded to the substrate 110 in which the ink passage is formed. A diaphragm 114 which constitutes a wall of the pressure chamber 111 in the present embodiment is vibrated by the piezoelectric actuator 140. The piezoelectric actuator 140 vibrates the diaphragm 114 to provide a driving force to the pressure chamber 111 for ink ejection. The piezoelectric actuator 140 includes a common electrode 141, a piezoelectric layer 142 that is deformed according to the application of a voltage, and a driving electrode 143 to which a driving voltage is applied from a driving unit or a controller 150.

When the substrate 110 is formed of a silicon wafer, an insulating layer (not shown) is formed between the piezoelectric actuator 140 and the substrate 110. The insulating layer may be, for example, a silicon oxide layer formed using a plasma chemical evaporation deposition (PECVD) method on the substrate 110. A piezoelectric layer 142 can be formed by coating a piezoelectric material in a paste form on the common electrode 141 to have a predetermined thickness and then sintering. The piezoelectric layer 142 is formed to correspond to the pressure chamber 111. Various piezoelectric materials can be used. For example, lead zirconate titanate (PZT) ceramic may be used.

The common electrode 141 and the driving electrode 143 are formed of a conductive metal. Each of the common electrode 141 and the driving electrode 143 may be formed of one metal layer or two metal layers such as Ti layer and Pt layer. The common electrode 141 and the driving electrode 143 may be formed by depositing Ti and Pt on the surface of the insulating layer and the piezoelectric layer 142 to a predetermined thickness using a sputtering method. Also, the common electrode 141 and the driving electrode 143 may be formed of a conductive metal on the insulating layer and the piezoelectric layer 142, for example, by screen-printing Ag—Pd paste. When the common electrode 141 and the driving electrode 143 are formed by screen-printing Ag—Pd paste, the piezoelectric layer 142, the common electrode 141, and the driving electrode 143 are sintered at a predetermined temperature, for example, in the range of 900 to 1000° C. Afterwards, a poling process is performed by applying an electric field to the piezoelectric layer 142 to generate piezoelectric characteristics. The piezoelectric layer 142 can also be formed by attaching a bulk piezoelectric material on the insulating layer.

The scope of the present general inventive concept is not limited to the structure of the inkjet printer illustrated in FIG. 1 and the inkjet printhead 100 illustrated in FIG. 2. For example, instead of the piezoelectric inkjet printhead illustrated in FIG. 2, a thermal inkjet printhead which ejects ink due to an expansion force of ink bubbles generated by thermal energy may also be applied. In this case, the heat source, that is, a heater, is the actuator.

Hereinafter, a method of preventing drying of ink and a printing method according to an embodiment of the present general inventive concept will be described.

While no printing is performed, the inkjet printhead 100 is positioned at the standby position. When the inkjet printhead 100 is at the standby position for a long period of time, a nozzle 122 may be capped using the capping unit 105 such that the ink inside the nozzle 122 is not exposed to an outside thereof. Obviously, the nozzle 122 may not be capped at a short standby time between printing operations.

When solvents in the ink inside the nozzle 122 evaporate, the viscosity of the ink is increased, and as the evaporation goes on, a thin layer is formed on the surface of the ink. Even when the inkjet printhead 100 is capped, it is possible that the viscosity of the ink increases for longer standby times. The ink may also be dried while the inkjet printhead 100 is moved from a standby position to a printing position to perform printing. If printing is performed in such a state, poor ejection or distortion of ejection direction may occur at an initial stage of printing.

FIG. 3 illustrates an auxiliary pulse Pa and a main pulse Pm to be used in the printing method according to an embodiment of the present general inventive concept. According to the current embodiment of the present general inventive concept, an auxiliary pulse Pa is applied to the piezoelectric actuator 140 when the inkjet printhead 100 at the standby position is moved to a printing position, and when the inkjet printhead 100 arrives at the printing position, a main pulse Pm is applied to the piezoelectric actuator 140 to eject ink, in performing a printing operation.

The auxiliary pulse Pa has a size of a voltage Va at which ink is not ejected, and the voltage Va is smaller than a voltage Vm of a main pulse Pm for ejecting ink. As illustrated in FIG. 4, a meniscus 124 is formed on a boundary between the ink in the nozzle 122 and the outside. When the auxiliary pulse Pa is applied, no ink is ejected because the potential of the piezoelectric layer 142 is small, but the meniscus 124 is vibrated as directed by an arrow A in the nozzle 122. Then the ink flows locally in the nozzle 122. Thus the ink near the meniscus 124 does not remain motionless and fresh ink is supplied to near the meniscus 124. Accordingly, drying of ink near the nozzle 122 can be prevented while the inkjet printhead 100 is moved from the standby position to the printing position, thereby preventing poor ejection or distortion of ejection direction at the initial stage of printing.

Applying an auxiliary pulse Pa while the inkjet printhead 100 is moved from the standby position to the printing position also has the following effect when the viscosity of the ink near the meniscus 124 is increased already or when a thin layer is formed on the meniscus 124. When the meniscus is vibrated, the highly viscous ink or the thin layer attached to an inner wall 123 of the nozzle 122 is separated from the inner wall of the nozzle 122, and fresh ink is supplied between the highly viscous ink or the thin layer and the inner wall 123 of the nozzle 122. Accordingly, poor ejection or distortion of ejection direction at the initial stage of printing can be prevented.

That is, a portion of ink contained in the ink pressure chamber and disposed in the nozzle 122, a portion of ink disposed around an inner wall of the nozzle 122, and at least a portion of the ink disposed in the pressure chamber move together according to waved generated according to the auxiliary pulse Pa applied to activate the inkjet printhead 100.

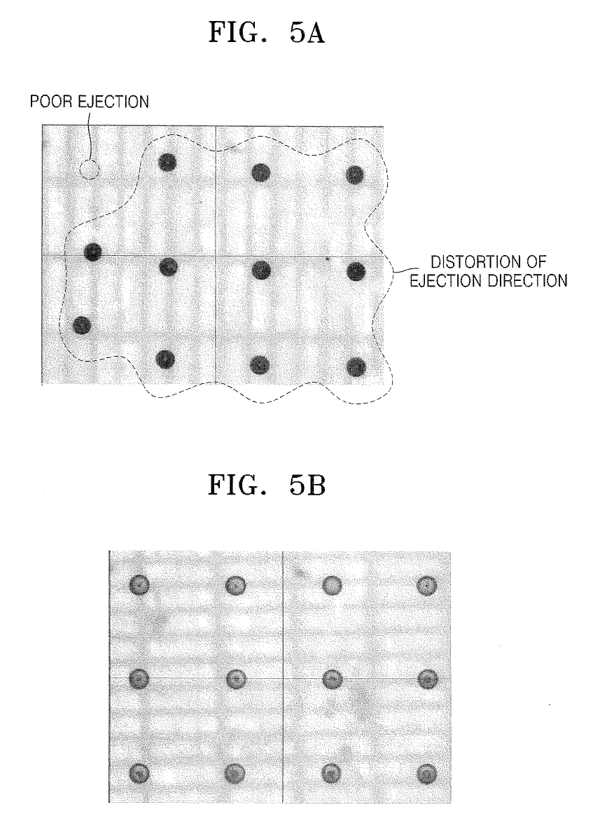

FIGS. 5A and 5B are photographic images obtained from experiments performed to check the printing state at the initial stage when applying no auxiliary pulse Pa and applying an auxiliary pulse Pa, respectively. FIG. 5A is a photographic image showing printing at the initial stage of printing in the case where a standby time of about 110 seconds had passed after an initial printing was performed, and then the printing was performed by directly applying a main pulse Pm without applying an auxiliary pulse Pa. Referring to FIG. 5A, poor ejection can be seen where no ink is ejected, and ejection direction is also distorted. Poor ejection means omission of image to be printed, and in the case of color printing, exact color image may not be easily printed. Also, distortion of ejection direction disables precise image printing, and particularly in color printing, colors may be mixed, thereby decreasing printing quality.

FIG. 5B is a photographic image showing printing in the case where a standby time of about 520 seconds had passed after an initial printing was performed, and then the printing was performed by applying a main pulse Pm after an auxiliary pulse Pa had been applied. Referring to FIG. 5B, despite the longer standby time, ink is ejected on the exact position without poor ejection at the initial stage of printing.

Before moving the inkjet printhead 100 from the standby position to the printing position A, a spitting operation ejecting ink may be performed several times by applying a main pulse Pm to the piezoelectric actuator 140. Thus the highly viscous ink due to drying is ejected at the standby state.

Also, when the inkjet printhead 100 is positioned at the standby position, an auxiliary pulse Pa may be applied to the piezoelectric actuator 140 continuously or intermittently to vibrate the meniscus 124.

Also, in whatever position the inkjet printhead 100 is positioned, the meniscus 124 can be vibrated by applying an auxiliary pulse Pa to the piezoelectric actuator 140 continuously or intermittently while no printing is performed.

According to the method of preventing drying of ink and the printing method according to the present general inventive concept, the problems of poor ejection or distortion of ejection direction due to drying of ink can be solved. Recently, the inkjet printing methods have been used in manufacturing processes of a color filter of a liquid crystal display device, in manufacturing processes of an organic light emitting diode (OLED), and in manufacturing processes of an organic thin layer transistor (OTFT). In these manufacturing processes, very precise ejection is required. According to the method of preventing drying of ink and the printing method according to the present embodiment, ink can be ejected on the exact position without poor ejection, and thus the yield can be increased and high quality products can be obtained. In addition, the ink used in the above described manufacturing processes may have various properties by including pigments for color filter, organic light emitting material, or semiconductor material. Ink having various drying characteristics can be used depending on the manufacturing processes. According to the present general inventive concept, ink having various drying characteristics can be stably ejected without poor ejection or distortion of ejection direction, and the method of preventing drying of ink and the printing method according to the present general inventive concept can be applied to various manufacturing processes.

As described above, according to the method of preventing drying of ink and the printing method according to the present general inventive concept, following advantages can be obtained.

First, poor ejection or distortion of ejection direction due to drying of ink can be prevented, thereby realizing high printing quality.

Second, since various types of ink can be stably ejected without poor ejection or distortion of ejection direction, the method of preventing drying of ink and the printing method according to the present general inventive concept can be applied to various manufacturing processes.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents

What is claimed is:

1. A method of printing of an inkjet printer, the method comprising:
vibrating a meniscus of ink in a nozzle by applying an auxiliary pulse having a size not large enough to generate ink ejection to an actuator which provides driving force for ink ejection while an inkjet printhead moves from a standby position to a printing position; and
printing by applying a main pulse to eject ink when the inkjet printhead arrives at the printing position.

2. The method of claim 1, further comprising:
applying the auxiliary pulse to the actuator while the inkjet printhead is positioned at the standby position.

3. The method of claim 1, wherein the auxiliary pulse is applied to the actuator while no printing is performed.

4. The method of claim 1, wherein, before moving the inkjet printhead to the printing position, a spitting operation to eject ink is performed several times at the standby position.

5. The method of claim 4, further comprising:
applying the auxiliary pulse to the actuator while the inkjet printhead is positioned at the standby position.

6. The method of claim 4, wherein the auxiliary pulse is applied to the actuator while no printing is performed.

7. A method of preventing drying of ink of an inkjet printhead, the method comprising:
vibrating a meniscus of ink in a nozzle by applying an auxiliary pulse having a size not large enough to generate ink ejection to an actuator which provides driving force for ink ejection, when no printing is performed, so that the ink in the nozzle flows and thus the ink near the nozzle is not dried.

8. A method of an image forming apparatus, the method comprising:
generating an auxiliary signal to generate one or more waves to vibrate at least a portion of ink disposed in a nozzle in a non-printing operation.

9. The method of claim 8, further comprising:
generating a main driving signal to eject ink through the nozzle in a printing operation.

10. The method of claim 8, further comprising:
controlling a printhead having the nozzle to move between a standby position and a printing position with respect to a medium,
wherein the auxiliary signal is applied to the printhead when the printhead is in the standby position.

11. The method of claim 8, wherein the generating of the auxiliary signal comprises generating the auxiliary signal having a level such that the portion of the ink disposed in the nozzle is not ejected through the nozzle.

12. The method of claim 8, wherein the generating of the auxiliary signal comprises controlling the portion of the ink to move within the nozzle.

13. An image forming apparatus comprising:
a printhead having a nozzle; and
a controller to generate an auxiliary signal the printhead to generate one or more waves to vibrate at least a portion of ink disposed in the nozzle in a non-printing operation.

14. The apparatus of claim 13, wherein the controller controls the printhead having the nozzle to move between a standby position and a printing position with respect to a medium, and the auxiliary signal is applied to the printhead when the printhead is in the standby position.

15. The apparatus of claim 13, wherein the controller generates the auxiliary signal having a level such that the portion of the ink disposed in the nozzle is not ejected through the nozzle.

16. The apparatus of claim 13, wherein the controller controls the portion of the ink to move within the nozzle.

17. The apparatus of claim 13, wherein the controller controls the portion of the ink to change a contact point between a surface of the ink and an inner wall of the nozzle.

18. The apparatus of claim 13, wherein the controller generates the auxiliary signal according to a time period from a printing operation.

19. The apparatus of claim 13, wherein the controller generates the auxiliary signal according to a time period from an ink ejection operation

20. The apparatus of claim 13, wherein the controller generates a main driving signal to eject the ink from the nozzle, and the auxiliary signal is a small signal than the main driving signal.
